(19) United States
(12) Patent Application Publication
(10) Pub. No.: US 2010/0002011 A1
(43) Pub. Date: Jan. 7, 2010

(54) IMAGE PROCESS METHOD AND CIRCUIT THEREOF

(75) Inventors: Meng-Chao Kao, Taipei (TW); Tzu-Chiang Shen, Taoyuan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: CHUNGHWA PICTURE TUBES, LTD., Taoyuan (TW)

(21) Appl. No.: 12/366,653

(22) Filed: Feb. 6, 2009

(30) Foreign Application Priority Data
Jul. 4, 2008 (TW) 97125239

(51) Int. Cl. G09G 5/00

(52) U.S. Cl. 345/611

(57) ABSTRACT

An image process method is provided and includes following steps: First, a first image is provided. Then, a smoothing process is performed on the first image to generate a second image. Thereafter, a difference image is generated by comparing the first image and the second image and a dynamic contrast stretch process is performed on the second image to generate a third image. In addition, a displaying image is generated by adding the difference image and the third image.

### CROSS-REFERENCE TO RELATED APPLICATION

This application claims the priority benefit of Taiwan application serial no. 97125239, filed Jul. 4, 2008. The entirety of the above-mentioned patent application is hereby incorporated by reference herein and made a part of specification.

### BACKGROUND OF THE INVENTION

1. Field of the Invention

The present invention relates to an image process technique, and in particular, to an image process method capable of suppressing noise, and an image process circuit.

2. Description of Related Art

Image enhancement is one of the most important techniques of digital image processing. A main object of the image enhancement is to improve the image quality by using image enhancement techniques. In respect of a frame displayed by a display nowadays, due to factors such as sites, light, users' improper use, it is often difficult for human eyes to observe and understand image information displayed on the frame directly and smoothly. The problems causing the difficulty are, for example, noise of the image, the image being somewhat bright, and the image being somewhat dark.

In solution, the display may perform a dynamic contrast stretch process on the image. In detail, the dynamic contrast stretch process merely re-distributes gray levels of the input image, so as to increase a gray level distribution range and effectively enhance contrast of the image. As shown by FIG. 1A, FIG. 1A is a histogram of the image characteristics of the input image. In FIG. 1A, the gray level distribution of the input image is between 0 and 200 levels. After performing the dynamic contrast stretch process on the input image, the gray level distribution is enlarged to be between 0 and 255 levels shown by FIG. 1B. Thereby, after performing the dynamic contrast stretch process on the input image, the input image can present high contrast image quality. It should be noted that when performing the dynamic contrast stretch process, noise originally existing in the input image are simultaneously stretched. The problem impedes the enhancement of the image quality and should be improved.

### SUMMARY OF THE INVENTION

Accordingly, the present invention is directed to an image process method which can stretch an image and suppress noise effectively.

The present invention is directed to an image process circuit which can carry out the image process method.

The present invention provides an image process method including steps as follows. First, a first image is provided. Next, a smoothing process is performed on the first image to generate a second image. Then, the first image and the second image are compared to generate a difference image, and a dynamic contrast stretch process is performed on the second image to generate a third image. Furthermore, the difference image and the third image are added to generate a displaying image.

According to one embodiment of the present invention, the first image is displayed by a plurality of pixels, and the pixels are respectively corresponding to a plurality of gray level values.

According to one embodiment of the present invention, the smoothing process at least includes steps as follows. First of all, a matrix is selected from the pixels used for displaying the first image. The matrix includes 3 columns and 3 rows of pixels. After that, the gray level value of the pixel at a center of the matrix is replaced with a median of the gray level values in the matrix.

According to one embodiment of the present invention, the smoothing process further includes providing a plurality of virtual gray level values, so that the pixels of an edge of the first image can form the matrix.

According to one embodiment of the present invention, the virtual gray level values are the gray level values of the pixels of the edge of the first image.

According to one embodiment of the present invention, the dynamic contrast stretch process includes steps as follows. The first image is detected at first to obtain a highest gray level value and a lowest gray level value. Next, the gray level value of each of the pixels of the second image is substituted into a formula below, so as to correspondingly obtain a gray level value of each of the pixels the third image.

$$255 \times \frac{\begin{matrix}the gray level value of each of the pixels of the second image - \\ the lowest gray level value\end{matrix}}{the highest gray level value - the lowest gray level value}$$

According to one embodiment of the present invention, in the image process method, the dynamic contrast stretch process includes steps as follows. The second image is detected at first to obtain a highest gray level value and a lowest gray level value. Next, the gray level value of each of the pixels of the second image is substituted into a formula below, so as to correspondingly obtain the gray level value of each of the pixels the third image.

$$255 \times \frac{\begin{matrix}the gray level value of each of the pixels of the second image - \\ the lowest gray level value\end{matrix}}{the highest gray level value - the lowest gray level value}$$

The present invention provides an image process circuit including a smoothing process module, a difference output module, an image stretch module, and an image combination module. The smoothing process module is suitable for receiving a first image and outputting a second image. Furthermore, the difference output module is coupled to the smoothing process module. The difference output module is suitable for comparing the first image with the second image, so as to output a difference image. The image stretch module is coupled to the smoothing process module. The image stretch module is suitable for receiving the first image or the second image, so as to output a third image. The image combination module is respectively coupled to the difference output module and the image stretch module. The image combination module is used for combining the difference image and the third image to generate a displaying image.

According to the present invention, the image process method generates the third image by performing the dynamic contrast stretch process on the second image which is generated from performing the smoothing process. Therefore, the third image can suppress the noise effectively. Then, the third image of the present invention and the difference image are added to generate the displaying image with good quality. Furthermore, the image process method of the present invention can be carried out by using the image process circuit.

In order to make the aforementioned and other objects, features and advantages of the present invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a histogram of the image characteristics of a conventional input image.

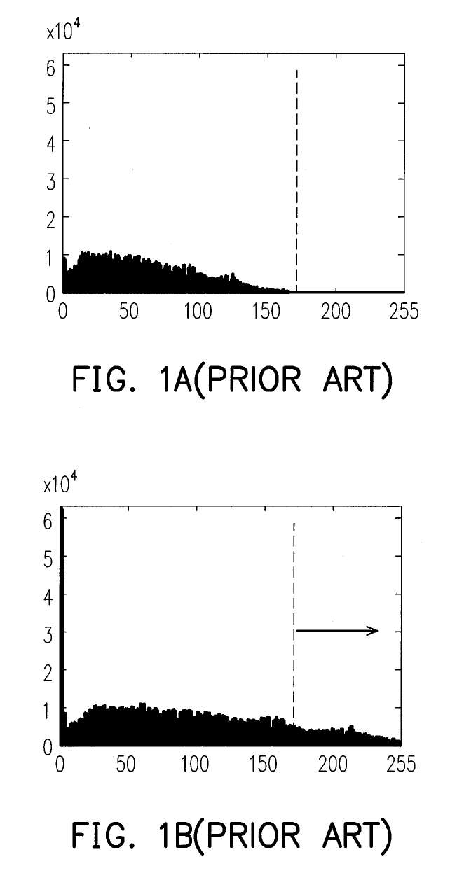

FIG. 1B is a histogram of the image characteristics of the conventional input image processed by a dynamic contrast stretch process.

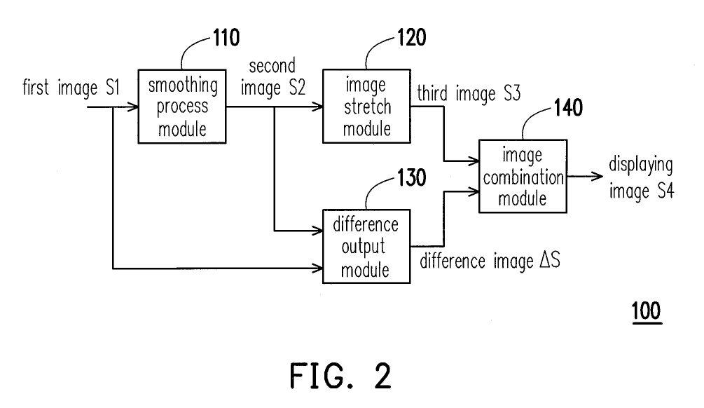

FIG. 2 is a schematic view of an image process circuit according to one embodiment of the present invention.

FIGS. 3A-3B are schematic views illustrating a smoothing process according to one embodiment of the present invention.

### DESCRIPTION OF EMBODIMENTS

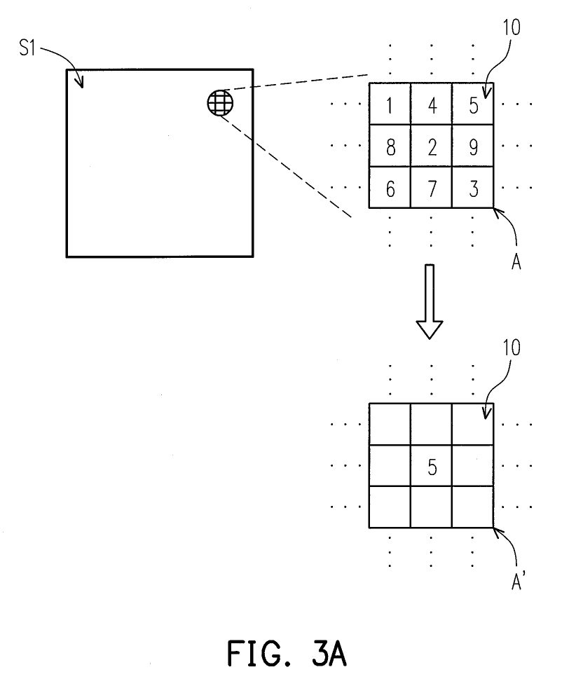

FIG. 2 is a schematic view of an image process circuit according to one embodiment of the present invention. Referring to FIG. 2, an image process circuit 100 of the present invention includes a smoothing process module 110, an image stretch module 120, a difference output module 130, and an image combination module 140. The smoothing process module 110 is coupled to the image stretch module 120 and the difference output module 130. On the other hand, the image stretch module 120 and the difference output module 130 are connected to an image combination module 140.

In detail, the image process method of the present invention includes steps as follows. First of all, a first image S1 is provided, and a smoothing process is performed on the first image S1 by using the smoothing process module 110, so as to generate a second image S2. Generally speaking, the first image S1 may be a movie image, a television image, or other images to be displayed. There are various methods to implement the smoothing process. An example set forth below is merely for illustration, and is not intended to limit the present invention.

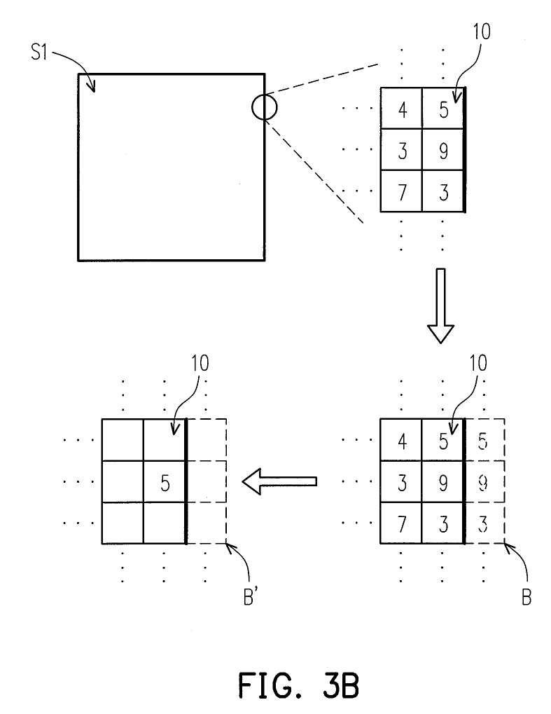

FIGS. 3A-3B are schematic views illustrating a smoothing process according to one embodiment of the present invention. Referring to FIG. 3A at first, the first image S1 is displayed by a plurality of pixels 10. The pixels 10 are respectively corresponding to a plurality of gray level values. For example, the 9 pixels 10 in a matrix A may correspond to 9 gray level values respectively. First of all, the matrix A is selected from the pixels 10 used for displaying the first image S1. The matrix A has 3 columns and 3 rows of pixels. That is, the matrix A is a 3×3 matrix. It should be noted that, the dimension of the matrix A can be adjusted as required, e.g. a 5×5 matrix or a 6×6 matrix.

After that, the gray level value of the pixel 10 at a center of the matrix A is replaced with a median of the gray level values in the matrix A. It can be known from FIG. 3A that, the median of the gray level values in the matrix A is 5, and therefore, the new gray level value at the center of a matrix A′ is 5. By repeating the above-mentioned methods, the smoothing process is performed on different regions of the first image S1.

It should be noted that two columns of the pixels 10 in a fringe region of the first image S1 cannot form a matrix. Therefore, as shown by FIG. 3B, the smoothing process of the present invention further includes providing a plurality of virtual gray level values (e.g. 5, 9 and 3), so that the pixels 10 of the edge of the first image S1 can form a matrix B. The virtual gray level values are, for example, repeating the gray level values of the pixels 10 of the edge of the first image S1. The median of the gray level values in the matrix B is 5, and therefore, the new gray level value at the center of a matrix B′ is 5. Repeating the above steps, the second image S2 is generated through performing the smoothing process on the first image S1. Certainly, persons of ordinary skill in the art should know that the smoothing process can be modified as required.

Then, referring to FIG. 2, the first image S1 and the second image S2 are compared to generate a difference image ΔS, and a dynamic contrast stretch step is performed on the second image S2 to generate a third image S3. In practice, the difference output module 130 outputs the difference image ΔS after receiving the first image S1 and the second image S2. The difference image ΔS may be, for example, details of the image. Particularly, because the second image S2 is processed by the smoothing process, a problem of the noise being stretched can be suppressed effectively in the dynamic contrast stretch process.

For example, the dynamic contrast stretch process may include detecting the first image S1 at first to obtain a highest gray level value and a lowest gray level value. Certainly, the highest gray level value and the lowest gray level value can be obtained by detecting the second image S2. Next, the gray level value of each of the pixels 10 in the second image S2 is substituted into a formula below, so as to correspondingly obtain the gray level value of each of the pixels 10 of the third image S3.

$$255 \times \frac{\begin{matrix}the gray level value of each of the pixels of the second image - \\ the lowest gray level value\end{matrix}}{the highest gray level value - the lowest gray level value}$$

Continuing to refer to FIG. 2, the image combination module 140 can add the difference image ΔS and the third image S3 to generate a displaying image S4. In other words, the details of the image will combine with the third image S3 processed by the dynamic contrast stretch process, so as to generate the displaying image S4 with the high contrast and the low noise.

In summary, according to the present invention, the image process method generates the third image by performing the dynamic contrast stretch process on the second image processed by the smoothing process. Thereby, the noise can be suppressed effectively. Then, the third image of the present invention and the difference image are added to generate the displaying image with the high quality and the low noise. Furthermore, the image process method of the present invention can be carried out by using the image process circuit of the present invention.

Although the present invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. An image process method, comprising:
providing a first image;
performing a smoothing process on the first image to generate a second image;
comparing the first image and the second image to generate a difference image, and performing a dynamic contrast stretch process on the second image to generate a third image; and
adding the difference image and the third image to generate a displaying image.

2. The image process method according to claim 1, wherein the first image is displayed by a plurality of pixels, and the pixels are respectively corresponding to a plurality of gray level values.

3. The image process method according to claim 2, wherein the smoothing process at least comprises:
selecting a matrix from the pixels used for displaying the first image, and the matrix including 3 columns and 3 rows of pixels; and
replacing the gray level value of the pixel at a center of the matrix with a median of the gray level values in the matrix.

4. The image process method according to claim 3, wherein the smoothing process further comprises providing a plurality of virtual gray level values, so that the pixels of an edge of the first image can form the matrix.

5. The image process method according to claim 4, wherein the virtual gray level values are the gray level values of the pixels of the edge of the first image.

6. The image process method according to claim 2, wherein the dynamic contrast stretch process comprises:
detecting the first image, so as to obtain a highest gray level value and a lowest gray level value;
substituting the gray level value of each of the pixels in the second image into a formula below, so as to correspondingly obtain a gray level value of each of the pixels of the third image.
$$255 \times \frac{\begin{matrix}the gray level value of each of the pixels of the second image - \\ the lowest gray level value\end{matrix}}{the highest gray level value - the lowest gray level value}$$

7. The image process method according to claim 2, wherein the dynamic contrast stretch process comprises:
detecting the second image, so as to obtain a highest gray level value and a lowest gray level value;
substituting the gray level value of each of the pixels in the second image into a formula below, so as to correspondingly obtain a gray level value of each of the pixels of the third image.
$$255 \times \frac{\begin{matrix}the gray level value of each of the pixels of the second image - \\ the lowest gray level value\end{matrix}}{the highest gray level value - the lowest gray level value}$$

8. An image process circuit, comprising:
a smoothing process module, suitable for receiving a first image and outputting a second image;
a difference output module coupled to the smoothing process module, and the difference output module being suitable for comparing the first image with the second image for outputting a difference image;
an image stretch module coupled to the smoothing process module, and being suitable for receiving the first image or the second image for outputting a third image; and
an image combination module respectively coupled to the difference output module and the image stretch module, and being used for combining the difference image and the third image to generate a displaying image.
